(19) United States
(12) Patent Application Publication
(10) Pub. No.: US 2008/0288781 A1
(43) Pub. Date: Nov. 20, 2008

(54) SYSTEMS AND METHODS FOR SECURE PASSWORD CHANGE

(76) Inventors: Richard Lee Lawson, Oak Grove, MO (US); David Patrick Kickham, Blue Springs, MO (US); Clifton Douglas Chandler, Olathe, KS (US)

Correspondence Address: JOHN S. BEULICK (12729 +2000);ARMSTRONG TEASDALE LLP, ONE METROPOLITAN SQUARE, SUITE 2600, SAINT LOUIS, MO, 63102-2740, US

(21) Appl. No.: 11/750,476

(22) Filed: May 18, 2007

(51) Int. Cl. H04L 9/00

(52) U.S. Cl. 713/182

(57) ABSTRACT

Systems and methods for changing a user password are described. In one embodiment, the method includes determining at least one password equivalent value, determining a safe-to-transmit password value, determining a password change authentication value, transmitting, from a remote device to a controller, the password change authentication value and the safe-to-transmit password value, confirming the data integrity of the password change authentication value sent from the remote device to the controller, and storing a new password equivalent value.

### BACKGROUND OF THE INVENTION

This invention relates generally to signal controls and more specifically to changing a password for remote access to a signaling controller.

In a signaling or crossing installation controlled by a controller, certain parameters are monitored. Maintaining an on site specialist, or regularly sending a specialist to a site, is expensive and time consuming. As such, a remote access portal may be available to access such a controller. Access to a controller is provided via a “password required” login. Changing a user password, for example, when required by operating procedures, may involve encrypting the entire message between the controller and the remote browser using, for example, Secure Sockets Layer (SSL) protocol, public key encryption, or other secure message level capabilities. Such methods may require increased processing overhead and/or additional equipment to be included between a controller and a remote access point.

### BRIEF DESCRIPTION OF THE INVENTION

In one aspect, a method for changing a user password includes determining at least one password equivalent value, determining a safe-to-transmit password value, and determining a password change authentication value. These values are then transmitted from a remote device to a controller, which confirms the data integrity of the password change authentication value transmitted from the remote device, and stores the new password equivalent value.

In another aspect, a system of access protection for a controller includes a controller configured to transmit a password change operation web page to a user-operated web browser, determine a password change authentication value to be stored by the controller, compare the stored password change authentication value with the password change authentication value transmitted by a user-operated web browser, determine the new password equivalent value, and store the new password equivalent value. The system also includes a user-operated web browser configured to display a password change operation web page, determine a current password equivalent value, determine a new password equivalent value, determine a safe-to-transmit password value, determine a password change authentication value, and transmit the password change authentication value and the safe-to-transmit password value to the controller.

In another aspect, a method for changing a user password for a controller includes determining a current password equivalent value, determining a new password equivalent value, determining a safe-to-transmit password value, determining a password change authentication value, and transmitting the password change authentication value and the safe-to-transmit password value from a user-operated web browser to the controller. The method also includes determining a password change authentication value to be stored by the controller, comparing the password change authentication value stored by the controller and the password change authentication value transmitted by the user-operated web browser to the controller, and storing the new password equivalent value.

### BRIEF DESCRIPTION OF THE DRAWINGS

FIG. 1 is a schematic of an exemplary interface system for changing a user password of a railroad signal controller;

FIGS. 2A and 2B show a flow chart of an exemplary method for changing a password of a controller.

### DETAILED DESCRIPTION OF THE INVENTION

As used herein, the term “controller” may include any host server configured to store parameter data, create and serve web pages, and/or control signals and/or systems. A railroad signal controller is intended as exemplary only, and thus is not intended to limit in any way the definition and/or meaning of the term “controller.” Furthermore, although the invention is described herein in association with a railroad signal, it should be understood that the present invention is applicable to other host server systems. Accordingly, practice of the present invention is not limited to railroad signal controllers.

Remote access protection for a controller is provided via a “password required” login. The method used to communicate the user-entered password from the web browser to the controller is an irreversible, or sufficiently difficult to reverse, keyed-hash message authentication code (HMAC) algorithm in which the user-entered password is combined with two key values supplied by the controller. The password value and both key values must be known in order to correctly generate the result that will be accepted for login. Therefore, the two key values may be transmitted from the controller to the web browser over a non-secure network since such values are only useful if the third value, the password, is also known. Moreover, the result may be transmitted from the browser to the controller over the same non-secure network since this result is generated by an irreversible algorithm. As long as one of the two keys is changed on every login attempt, a different result is generated by the HMAC combination and the resulting value transmitted over the non-secure network is good for only one login attempt.

There may be a need for the password to be changed. The access protection approach described herein relies on the fact that the password value, or a password value equivalent, is known by the controller and the remote user but never disclosed on the non-secure network. If the password or its equivalent value is transmit undisguised during a password change operation, the access protection of the controller can be compromised.

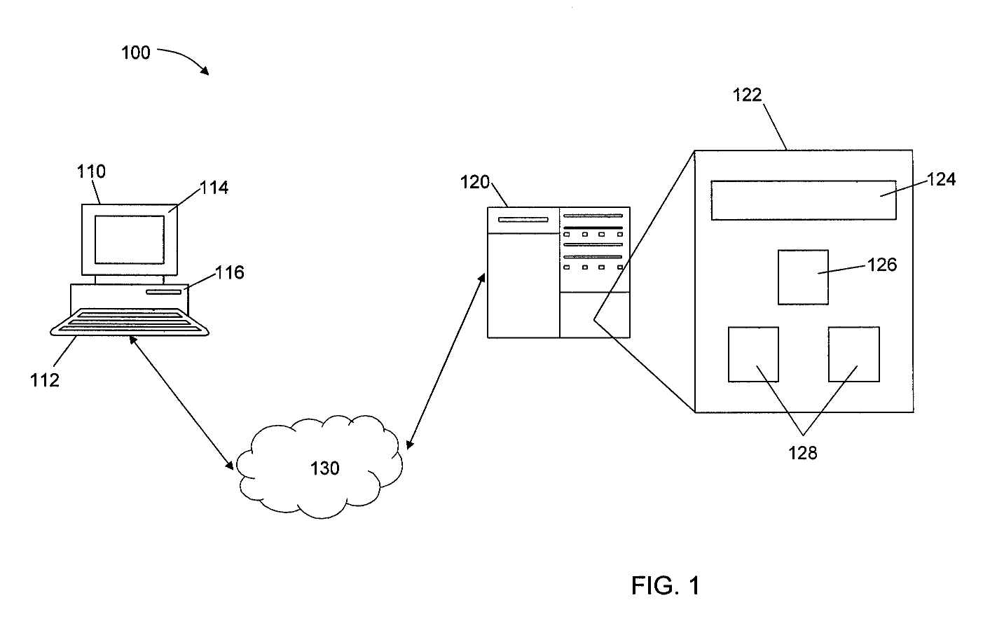

FIG. 1 is a schematic illustration of an exemplary interface system 100 for changing a user password of a railroad signal controller 120. System 100 includes a computer system 110 from which a remote user accesses controller 120. Computer system 110 includes a user input 112, a display 114, a processor 116, and a commercially available web browser (not shown) such as, but not limited to, Microsoft Internet Explorer or Mozilla Firefox. The web browser has the ability to display web pages containing scripting languages such as, but not limited to, JavaScript. Computer system 110 may be a complete off the shelf (COTS) unit or custom built to pre-determined specifications.

Computer system 110 connects to controller 120 via a standard Internet connection 130. Communication between computer system 110 and controller 120 is based on a client-server relationship using established protocols such as, but not limited to, Internet Protocol (IP).

Controller 120 is installed at a site that includes a railroad signal. Controller 120 includes a hardware module 122, shown in FIG. 1 in exploded form, and a local presence button (not shown).

In the exemplary embodiment, hardware module 122 includes an Ethernet interface 124, a communications processor 126, and two data integrity processors 128. Ethernet interface 124 allows controller 120 to connect to the Internet 130 and has a unique Internet address to which a remote user directs a web browser. Communications processor 126 serves web pages and passes data to, and receives data from, data integrity processors 128, via an internal module interface (not shown), and remote computer system 110 via Ethernet interface 124. Data integrity processors 128 cross-check data transmitted from communications processor 126.

Controller 120 also includes memory (not shown) for storing a database of, for example, passwords and login IDs. In the exemplary embodiment, the database contains a password equivalent value which is a combination of the actual password associated with a particular user and a specific location key unique to a particular controller 120. The combinational logic used to form the password equivalent is a keyed-hash message authentication code (HMAC) algorithm. An HMAC is a type of method authentication code calculated using a cryptographic hash function in combination with a secret key. In this case the secret key is the location key. It may be used to simultaneously verify both the data integrity and the authenticity of a message. Any iterative cryptographic hash function such as, but not limited to, MD-5 or SHA-1, may be used in the calculation.

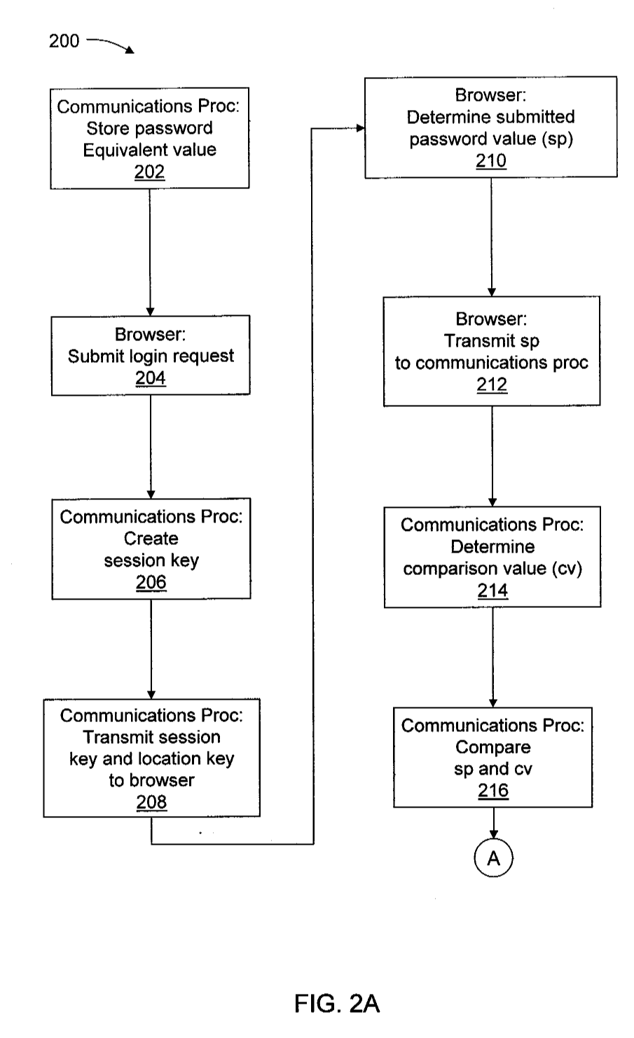

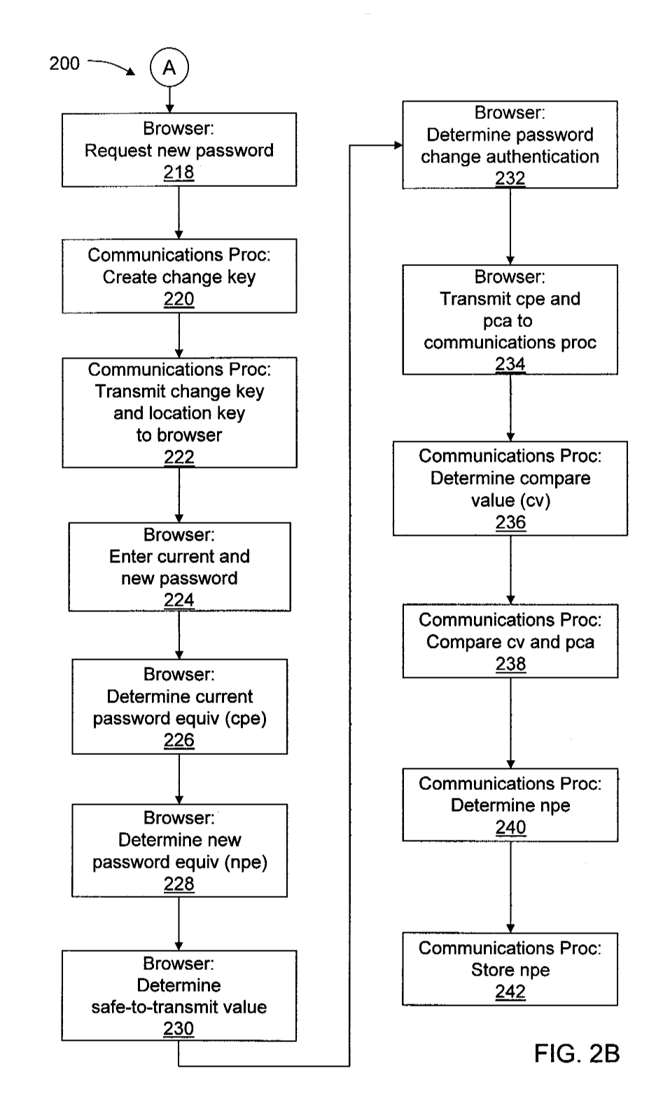

During use, a remote user must first login to controller 120 from the web browser of computer system 110. Upon successfully logging into controller 120, a remote user is presented with a home page. From the home page, the user may then choose to, for example, change a user password. FIGS. 2a and 2b show a flow chart of an exemplary method 200 for changing a user password.

As shown in FIG. 2A, and when attempting to login to controller 120 from computer system 110, a remote user directs the web browser to a pre-determined home page associated with a unique IP address for controller 120. As described above, access protection for controller 120 is provided via a “password required” login. In conjunction with the use of HMAC, the password value and two key values must be known in order to correctly generate the result that will be accepted for login. Therefore, the two key values may be transmitted from controller 120 to the web browser of computer system 110 over a non-secure network. This can be done because the two key values are only useful if the third value, the password, is also known.

In the exemplary embodiment, method 200 involves storing 202 a password equivalent value in memory of controller 120. The password equivalent value (pe) is formed by combining the password of the associated user with a location key value unique to controller 120, using the HMAC algorithm described above.

(pe)=HMAC(password, location key)

When a login attempt is made 204, communications processor 126 creates 206 a one-time-use session key that is valid for only one login session from a particular web browser. Communications processor 126 transmits 208 the location key value and the session key value to the web browser. The web browser of computer system 110 combines 210 the user-submitted password, the location key value, and the session key value to form a submitted password equivalent value (sp).

(sp)=HMAC(HMAC(password, location key), session key)

The web browser then transmits 212 the submitted password equivalent value to communications processor 126. Communications processor 126 then calculates 214 a comparison value (cv) using the password equivalent value stored in memory of controller 120.

(cv)=HMAC(pe, session key)

Communications processor 126 compares 216 the received submitted password equivalent value with the comparison value. If the comparison value is the same as the submitted password equivalent value, the login is granted, shown as point A in FIGS. 2A and 2B.

In the exemplary embodiment, and when the remote user has successfully logged into controller 120, the remote user may choose to change the current password to a new value. As shown in FIG. 2B, the remote user begins this process by requesting 218 a new password from a Change Password web page. Communications processor 126 creates 220 a one-time-use change key value, and transmits 222 this change key value, the location key value, and the necessary web page to the web browser. The remote user then enters both the current password and the desired new password, and submits 224 a request for a new password.

The web browser acts on this request by combining 226 the entered current password with the location key to obtain a current password equivalent value (cpe). The browser also combines 228 the entered new password with the location key to obtain a new password equivalent value (npe).

(cpe)=HMAC(current password, location key)

(npe)=HMAC(new password, location key)

Additionally, the web browser combines 230 the current password equivalent value and the new password equivalent value, using a logical operation such as, but not limited to, a bit-wise exclusive or (XOR) operation, to form a safe-to-transmit password value. Lastly, the web browser forms a password change authentication value (pca) by combining 232 the current password equivalent value and the one-time-use change key value.

(pca)=HMAC(cpe, change key)

In the exemplary embodiment, the web browser then transmits 234 the password change authentication value and the safe-to-transmit password value to communications processor 126. Communications processor 126 then combines 236 the currently stored password equivalent value with the one-time-use change key to form a comparison value (cv).

(cv)=HMAC(pe, change key)

Communications processor 126 compares 238 the comparison value with the password change authentication value sent from the web browser. If the values match, communications processor 126 uses a logical operation such as, but not limited to, a bit-wise exclusive or (XOR) operation, to combine 240 the safe-to-transmit password value that was transmitted from the web browser, and the password equivalent value stored in memory of controller 120. The result of this operation is the new password equivalent value. This value is then stored 242 by communications processor 126 in memory of controller 120.

The above-described methods and apparatus facilitate improving access protection and protection administration. Password changes may be performed without having to use and/or administer message level encryption, or having to include in-line network devices that encrypt the entire network traffic. Use of the HMAC algorithm facilitates password change security without using these more complicated means of security. As such, password equivalent values are used and combined with both static and one-time-use keys to effectively transmit private data over the Internet without using message level encryption.

Exemplary embodiments of methods and apparatus for securely changing a password are described in detail above. The methods and apparatus is not limited to use with the specific embodiments described herein, but rather, components of the methods and apparatus can be utilized independently and separately from other components described herein. Moreover, the invention is not limited to the embodiments of the methods and apparatus described above in detail. Rather, other variations of the methods and apparatus may be utilized within the spirit and scope of the claims.

While the invention has been described in terms of various specific embodiments, those skilled in the art will recognize that the invention can be practiced with modification within the spirit and scope of the claims.

What is claimed is:

1. A method for changing a user password, said method comprising:
determining at least one password equivalent value;
determining a safe-to-transmit password value;
determining a password change authentication value;
transmitting, from a remote device to a controller, the password change authentication value and the safe-to-transmit password value;
confirming the data integrity of the password change authentication value transmitted from the remote device to the controller; and
storing a new password equivalent value.

2. A method in accordance with claim 1 wherein determining at least one password equivalent value comprises:
using a keyed-hash message authentication code algorithm to combine a user-input current password with a location key, to form a current password equivalent value; and
using a keyed-hash message authentication code algorithm to combine a user-input new password with the location key, to form a new password equivalent value.

3. A method in accordance with claim 2 wherein determining a safe-to-transmit password value comprises performing logical operation to combine the current password equivalent value and the new password equivalent value.

4. A method in accordance with claim 1 wherein determining a password change authentication value comprises using a keyed-hash message authentication code algorithm to combine the at least one password equivalent value with a change key value.

5. A method in accordance with claim 1 wherein confirming the data integrity of the password change authentication value transmitted from the remote device to the controller comprises comparing the password change authentication value, transmitted from the remote device to the controller, with a password change authentication value generated by the controller.

6. A method in accordance with claim 1 wherein storing a new password value comprises:
performing a logical operation to combine the safe-to-transmit password value and a password equivalent value, stored by the controller, to recover the new password equivalent value; and
replacing a current password equivalent value, stored by the controller, with the result of the exclusive or operation.

7. A system of access protection for a controller, said system comprising:
a controller configured to:
transmit a password change operation web page to a user-operated web browser;
determine a password change authentication value;
receive a password change authentication value;
compare the password change authentication value with a password change authentication value transmitted by a user-operated web browser;
determine a new password equivalent value; and
store the new password equivalent value; and
a user-operated web browser configured to:
display a password change operation web page;
determine a current password equivalent value;
determine a new password equivalent value;
determine a safe-to-transmit password value;
determine a password change authentication value; and
transmit the password change authentication value and the safe-to-transmit password value to the controller.

8. A system for access protection of a controller in accordance with claim 7, the user-operated web browser further configured to determine a current password equivalent value based on a combination of a user-input current password and a location key using a keyed-hash message authentication code algorithm.

9. A system for access protection of a controller in accordance with claim 7, the user-operated web browser further configured to determine a new password equivalent value based on a combination of a user-input new password and a location key using a keyed-hash message authentication code algorithm.

10. A system for access protection of a controller in accordance with claim 7, the user-operated web browser further configured to determine a safe-to-transmit password value based on a logical operation to combine the current password equivalent value and the new password equivalent value.

11. A system for access protection of a controller in accordance with claim 7, the user-operated web browser further configured to determine a password change authentication value based on a combination of the current password equivalent value and a change key using a keyed-hash message authentication code algorithm.

12. A system for access protection of a controller in accordance with claim 7, the controller configured to determine a password change authentication value based on a combination of a password equivalent value stored by the controller, and a change key using a keyed-hash message authentication code algorithm.

13. A system for access protection of a controller in accordance with claim 7, the controller configured to determine the new password equivalent value based on a logical operation to combine the safe-to-transmit password value and a password equivalent value stored by the controller.

14. A method for changing a user password on a controller, said method comprising:
determining a current password equivalent value;
determining a new password equivalent value;
determining a safe-to-transmit password value;
determining a password change authentication value;
transmitting, from a user-operated web browser to the controller, the password change authentication value and the safe-to-transmit password value;
determining a password change authentication value to be stored by the controller;
comparing the password change authentication value, stored by the controller, and the password change authentication value transmitted by the user-operated web browser to the controller; and
storing the new password equivalent value.

15. A method in accordance with claim 14 wherein determining a current password equivalent value comprises using a keyed-hash message authentication code algorithm to combine a user-input current password and a location key.

16. A method in accordance with claim 14 wherein determining a new password equivalent value comprises using a keyed-hash message authentication code algorithm to combine a user-input new password and a location key.

17. A method in accordance with claim 14 wherein determining a safe-to-transmit password value comprises performing a logical operation to combine the current password equivalent value and the new password equivalent value.

18. A method in accordance with claim 14 wherein determining a password change authentication value comprises using a keyed-hash message authentication code algorithm to combine the current password equivalent value and a change key.

19. A method in accordance with claim 14 wherein determining a password change authentication to be stored by the controller value comprises using a keyed-hash message authentication code algorithm to combine a password equivalent value and a change key.

20. A method in accordance with claim 14 wherein storing the new password value comprises:
performing a logical operation to combine the safe-to-transmit password value and a password equivalent value to recover the new password equivalent value; and
replacing the current password equivalent value with the result of the exclusive or operation.
